(19) United States
(12) Patent Application Publication
(10) Pub. No.: US 2026/0128238 A1
(43) Pub. Date: May 7, 2026

(54) USE OF ZEOLITE-TEMPLATED CARBON (ZTCS) AS ELECTRODES FOR SUPERCAPACITORS

(71) Applicant: SAUDI ARABIAN OIL COMPANY, Dhahran (SA)

(72) Inventors: Yuguo WANG, Dhahran (SA); Ahmad D. HAMMAD, Dhahran (SA); Rashid OTHMAN, Khobar (SA)

(73) Assignee: SAUDI ARABIAN OIL COMPANY, Dhahran (SA)

(21) Appl. No.: 19/117,554

(22) PCT Filed: Oct. 3, 2022
(86) PCT No.: PCT/IB2022/059432

§ 371 Date: Apr. 1, 2025

(51) Int. Cl. H01G 11/44; H01G 11/24; H01G 11/26; H01G 11/34

(52) U.S. Cl. CPC H01G 11/44; H01G 11/24; H01G 11/26; H01G 11/34

(57) ABSTRACT

ZTCs are used as active material for electrodes for supercapacitors. The ZTCs are generated from CaX or NaX templates. Carbon vapor deposition is performed utilizing acetylene, ethanol, or propylene. The ZTC-zeolite composition is graphitized, cooled, and undergoes an acid wash to remove the zeolite template. The ZTC generated from the process features a high surface area, and is operable for use as an active material in a supercapacitor. The supercapacitor can also feature an H₂SO₄ electrolyte.

### CROSS-REFERENCE TO RELATED APPLICATIONS

This application claims the benefit and priority of PCT/IB2022/059432 filed on Oct. 3, 2022, and titled “USE OF ZEOLITE-TEMPLATED CARBON (ZTCS) AS ELECTRODES FOR SUPERCAPACITORS”. For purposes of United States patent practice, this application incorporates the contents of the International Application by reference in its entirety.

### FIELD

This disclosure relates to zeolite-templated carbon (ZTC) usage. Specifically, disclosed herein are electrodes for supercapacitors generated from ZTCs and the methods used to generate the ZTCs.

### BACKGROUND

Supercapacitors are electrochemical capacitors that store electrical energy. Supercapacitors have a lower weight, a faster discharge, faster charging, a longer lifetime of charge cycles, and excellent temperature performance in comparison with traditional battery or conventional capacitors. Performance of supercapacitors are related to several factors, including electrolyte selection and electrode material makeup. Capacitance is proportional to the surface area of the electrodes; thus, electrochemical inert materials with high specific surface areas are utilized. Conventional electrode materials include activated carbon, metal oxides, or graphite.

Conventional electrode materials lack uniform pores and channels, or have “dead pores” that prevent ion exchange. Additionally, traditional materials can be difficult to produce consistently in large batches, and have inconsistent manufacturing results. Therefore, a need exists for a material for use as supercapacitor electrodes with a high capacitance and a large surface area.

### SUMMARY OF THE INVENTION

Disclosed herein is a method for generating a zeolite-templated carbon (ZTC) for use as an active material in an electrode in a supercapacitor. The method includes the steps of providing a CaX zeolite at a select size, and performing carbon vapor deposition on the CaX zeolite in a plug-flow reactor using an organic precursor to generate a ZTC-zeolite composition. The carbon vapor deposition occurs at an elevated temperature. The method also includes the states of cooling the ZTC-zeolite composition; heating the ZTC-zeolite composition by introducing an inert gas stream for a defined period of time, and where the ZTC is heated to a graphitizing temperature in the range of 820 K to 1180 K, to generate a graphitized ZTC-zeolite composition; cooling the graphitized ZTC-zeolite composition; and washing the graphitized ZTC-zeolite composition with acid to generate a prepared ZTC. The prepared ZTC is operable for use as an active material in an electrode in a supercapacitor and has a select surface area. In some embodiments, the inert gas stream is a helium stream containing helium. In some embodiments, the inert gas stream is a nitrogen stream containing nitrogen. The inert gas stream is heated.

In some embodiments, the organic precursor is selected from the group including propylene, ethanol, acetylene, and combinations of the same. In other embodiments, the organic precursor includes propylene. In some embodiments, the acid is selected from the group including HCl, HF, and combinations of the same. The method also includes the step of drying the prepared ZTC. In some embodiments, the prepared ZTC defines micropores in the range of 1.5 to 2 nm and mesopores in the range of 2 to 5 nm. The elevated temperature is in the range of 800 K to 1080 K.

Further disclosed herein is a supercapacitor including an electrode, where the electrode includes an active material and a metallic component. The active material includes a zeolite-templated carbon (ZTC) generated by the methods claimed herein. The supercapacitor also includes an electrolyte solution including H₂SO₄ and a membrane separator.

In some embodiments, the supercapacitor retains a maximum of 75% of capacitance at high current densities of 15 A/g. In some embodiments, the ZTC has a surface area in the range of 2500 m²/g to 3000 m²/g. In some embodiments, the ZTC has a micropore density of greater than 1.0 cm³/g. In some embodiments, the supercapacitor has a capacitance is in the range of 100 to 250 F/g.

Further disclosed herein is a method for generating a zeolite-templated carbon (ZTC) for use as an active material in an electrode in a supercapacitor. The method includes the steps of providing a NaX zeolite; initiating ion exchange with the NaX zeolite and Ca⁺² ions to generate a large crystalline calcium (LCaX) zeolite; and performing carbon vapor deposition on the LCaX zeolite in a plug-flow reactor using acetylene to generate a ZTC-zeolite composition. The carbon vapor deposition occurs at an elevated temperature. The method also includes the states of cooling the ZTC-zeolite composition; heating the ZTC-zeolite composition by introducing an inert gas stream for a defined period of time, where the ZTC is heated to a graphitizing temperature in the range of 820 K to 1180 K, to generate a graphitized ZTC-zeolite composition; cooling the graphitized ZTC-zeolite composition; and washing the graphitized ZTC-zeolite composition with acid to generate a prepared ZTC. The prepared ZTC is operable for use as an active material in an electrode in a supercapacitor and has a select surface area. In some embodiments, the inert gas stream is a helium stream. The inert gas stream is heated.

In some embodiments, the elevated temperature is in the range of 820 K to 873 K. In some embodiments, the method also includes the step of performing a second carbon vapor deposition on the graphitized ZTC-zeolite composition using acetylene. The second carbon vapor deposition is performed at the elevated temperature. In some embodiments, the elevated temperature is in the range of 800 K to 873 K. In some embodiments, the acid is selected from the group including HCl, HF, and combinations of the same.

### BRIEF DESCRIPTION OF THE DRAWINGS

These and other features, aspects, and advantages of the present disclosure will become better understood with regard to the following descriptions, claims, and accompanying drawings. It is to be noted, however, that the drawings illustrate only several embodiments of the disclosure and are therefore not to be considered limiting of the scope as it can admit to other equally effective embodiments.

FIG. 1 is a depiction of a simplified supercapacitor.

FIG. 2 is a chart of the NH₃ temperature programmed desorption profiles of CaX and commercial NaX, according to an embodiment.

FIG. 3 is a chart of the X-ray diffraction pattern results for selected ZTCs, according to an embodiment.

FIG. 4 is a chart of the N₂ adsorption and desorption isotherms for selected ZTCs, according to an embodiment.

FIG. 5 is a chart of pore size distribution for selected ZTCs, according to an embodiment.

FIG. 6 is a chart of N₂ adsorption and desorption isotherms of the ZTC-zeolite composition for the LCaX-generated ZTCs, according to an embodiment.

FIG. 7A is a chart of N₂ adsorption and desorption isotherms of the LCaX-generated ZTCs, according to an embodiment.

FIG. 7B is a chart of pore size distribution for the LCaX-generated ZTCs, according to an embodiment.

FIG. 7C is a chart of the X-ray diffraction pattern of the LCaX-generated ZTCs, according to an embodiment.

FIG. 8A is a chart of the X-ray diffraction patterns comparing a propylene-based ZTC and commercially available activated carbon, according to an embodiment.

FIG. 8B is a chart of the N₂ adsorption and desorption isotherms comparing a propylene-based ZTC and commercially available activated carbon, according to an embodiment.

FIG. 9A is a chart of the cyclic voltammetry responses of electrodes containing a propylene-based ZTC and commercially available activated carbon, according to an embodiment.

FIG. 9B is a chart of the specific discharge capacitance as a function of current density comparing a propylene-based ZTC and commercially available activated carbon, according to an embodiment.

### DETAILED DESCRIPTION OF THE INVENTION

While the disclosure will be described with several embodiments, it is understood that one of ordinary skill in the relevant art will appreciate that many examples, variations and alterations to the systems and methods described are within the scope and spirit of the disclosure. Accordingly, the embodiments of the disclosure described are set forth without any loss of generality, and without imposing limitations, on the claims.

The terms “comprising,” “including,” “having,” and the like, as used with respect to embodiments of the present disclosure, are synonymous and are each intended to have an open, non-limiting meaning that does not exclude additional elements or steps. The terms “optional” or “optionally” mean that an element can be used for some embodiments, but can be omitted in other embodiments. The singular forms “a,” “an,” and “the” include plural referents, unless the context clearly dictates otherwise.

Methods of generating ZTCs and supercapacitors utilizing ZTCs as active materials in electrodes are disclosed. The ZTCs are generated using a CaX zeolite as a template, carbon vapor deposition, and various organic precursors. Supercapacitors using ZTCs as electrodes have specific capacitance two times larger than that of the conventional electrodes in supercapacitors. The supercapacitors disclosed herein can retain 75% of capacitance even at high current density of 15 A/g, which is superior to conventional activated carbon electrodes. The resulting ZTCs feature a large surface area, in some embodiments greater than 3000 m²/g. The ZTCs can also have a large micropore volume of over 1 cm³/g. Beneficially, a greater surface area and a greater micropore volume provides more surface for ions and charge adsorption when the ZTC is utilized as the active material in the supercapacitor. ZTCs exhibit high ion conductivity in addition to a high electronic conductivity when used as electrode materials due to the high surface area available for reduction and oxidation.

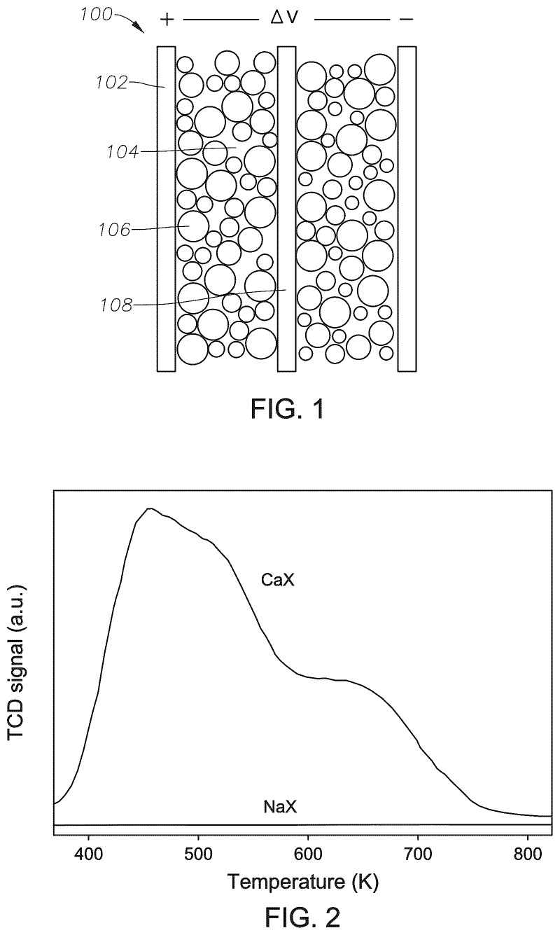

Supercapacitors function as an electrical double-layer capacitor and feature an electrode, an electrolyte, and a separator. Referring to FIG. 1, simplified supercapacitor 100 is depicted. Current collector 102 collects ions of the appropriate charge (positive on the positive side, negative on the negative side). Current collector 102 is made of a material possessing high electrical conductivity, low contact resistance with the electrode, and strong and stable bonding with the electrode. Current collector 102 is also compatible with the electrolyte and does not corrode or otherwise react with current collector 102 while the system is operating. Current collector 102 can be made of aluminum foil, which conducts current from the electrodes. The aluminum foil also supports the electrode. Electrolyte 104 allows for charge to be transferred. In some embodiments, electrolyte 104 is H₂SO₄. In some embodiments, hydroquinone is added to the electrolyte solution. Electrode 106 stores charged particles on the surface of the electrode. In embodiments disclosed herein, electrode 106 is a ZTC generated utilizing the methods disclosed herein. Separator 108 physically separates the electrodes to prevent a short circuit, but allows for the mobility of the charged ion while preventing electronic conductance. Separator 108 is a thin material, and can be a few hundredths of a millimeter, and porous to the conducting ions. Separator 108 is chemically inert in order to protect and preserve the stability and conductivity of the electrolyte. Separator 108 can be a membrane separator. Other materials appropriate for separator 108 can include open capacitor papers, nonwoven porous polymeric films containing materials like polyacrylonitrile, woven glass fibers, porous woven ceramic fibers, or combinations of the same.

Electrodes include an active material, which features a high surface area, and a metallic collector, which features high conductivity. The metallic collector can contain material similar to current collector 102. The energy storage in a supercapacitor is dependent upon the physisorption of electrolyte ions on the surfaces of the carbon electrode, and the stored energy is proportional to the number of ions absorbed on the electrode surface; therefore, electrodes with carbon materials featuring high surface areas result in a high specific/volumetric energy density. Uniform porosity with a three-dimensionally connected micropore structure result in significant high-power density of supercapacitors due to the high rate of ion transport within the micropore structures.

In embodiments disclosed herein, the electrode contains ZTC as an active material. ZTCs capable of being used as superconductors in the embodiments described herein include those ZTCs that feature both micropores and mesopores. In preferred embodiments disclosed herein, the ZTCs feature substantially only micropores such that the ZTC pores are primarily comprised and concentrated in the micropore region. Micropores have diameters equal to or less about than 2 nanometers. Mesopores have diameters between about 2 nanometers and about 5 nanometers. Macropores have diameters greater than about 5 nanometers. The ZTCs utilized as active material in supercapacitors in the embodiments disclosed herein feature enhanced microporosity and consistent interconnected micropores, resulting in supercapacitor performance enhancements.

The ZTCs disclosed herein are generated in a process using zeolite as a template. A zeolite of a selected size is used as a template. The selected size can be a small crystal form or a large crystal form. Small crystal forms can be in the range of 1-2 μm, and large crystal forms can be in the range of 10-20 μm. In some embodiments, NaX is the zeolite used in producing the ZTC. In some embodiments, 1 g of zeolite is added to a plug flow reactor. A heated inert gas stream is introduced to the zeolite raising the temperature to an elevated temperature. The heated inert gas stream can be an He stream containing substantially helium, which may contain impurities that do not substantially affect the process. The heated inert gas stream can be a nitrogen stream containing substantially nitrogen, which may contain impurities that do not substantially affect the process. The heated inert gas stream heats the zeolite. Beneficially, the helium or nitrogen provides an inert environment, and can be used throughout the process providing other advantages such as further dehydrogenating the compositions for graphitization. The elevated temperature can be in the range of 800 K to 1080 K; alternately, 820 K to 1180 K; alternately, 823 K to 873 K; alternately, 823 K to 973 K; alternately, 823 K to 1073 K; alternately, 870 K to 1023 K; alternately, 873 K to 973 K; and alternately, 873 K to 1023 K. In some embodiments, the elevated temperature in is the range of 970 K to 1000 K. In some embodiments, the elevated temperature is 823 K, alternately 873 K, alternately 973 K, alternately 1023 K, and alternately 1073 K.

After the temperature of the zeolite has been raised and held for a period of time, in some embodiments 30 minutes, a stream containing one or more of organic precursor are introduced to the ZTC. The organic precursor can be heated. When passing through the bed, the organic precursor temperature reaches the same temperature as the zeolite. In some embodiments, the organic precursors include propylene, ethanol, acetylene, or combinations of the same. In some embodiments, the organic precursor is acetylene. In preferred embodiments, the organic precursor is propylene. Carbon is deposited within the template through carbon vapor deposition in a plug-flow reactor. The organic precursors form a 3-dimensional negative of the zeolite template interwoven between the channels of the zeolite, generating a ZTC-zeolite composition. After a period of time, the organic precursor flow is stopped and an He stream is used to reduce the temperature of the zeolite template to room temperature. In some embodiments, the carbon vapor deposition time is in the range of 2 to 9 hours, alternately 4 to 9 hours, and alternately 4 to 5 hours. In some embodiments, the carbon vapor deposition time is 2 hours, alternately 4 hours, alternately 5 hours, alternately 6 hours, and alternately 9 hours.

In some embodiments, the ZTC-zeolite composition is further heated to graphitize the ZTC. This heating can be performed by a second inert gas stream that is heated, such as a heated helium stream or a heated nitrogen stream. The heated helium or nitrogen stream can also further dehydrogenate the ZTC-zeolite composition for graphitization. The temperature for graphitization can be in the range of 820 K to 1180 K, and alternately 1100 K to 1180 K. In some embodiments, the temperature for graphitization is 1123 K. In some embodiments, the temperature for graphitization is 1173 K. In some embodiments, the graphitization time is 4 hours. In some embodiments, the graphitization time is in the range of 2 to 9 hours. The ZTC-zeolite composition is then cooled, and washed with an acid. The zeolite is dissolved by the acid so that the ZTC remains. The ZTC-zeolite composition is acid washed with HCl, HF, or combination of the same for 1 hour, removing the zeolite and generating the ZTC. In some embodiments, the acid wash occurs twice. After acid washing, the ZTC is rinsed with water and dried. In some embodiments, the drying occurs at 373 K.

In preferred embodiments, CaX is utilized as the zeolite for the generation of the ZTC for use in the electrode for the supercapacitors. The CaX is generated by performing ion-exchange on a commercial grade NaX zeolite. In some embodiments, a 10 m sample of NaX is added into 200 mL of a 0.32 M Ca(NO₃)₂ solution and stirred for a period of 4 hours. The commercial grade NaX zeolite is easily obtainable, and does not feature large or ultra-large crystal forms. In some embodiments, the CaX generated has small crystallites that have been generated in the range of 1 to 2 μm.

Advantageously, the use of CaX generated by Ca⁺² exchange can generate acid sites in the zeolite which catalyze the carbon deposition within the zeolite micropores and allows for selective carbon deposition within the micropores. The generation of the acid sites beneficially increases the thermal stability of the zeolite template during the carbon vapor deposition step, resulting in more consistent ZTC generation and higher quality ZTCs.

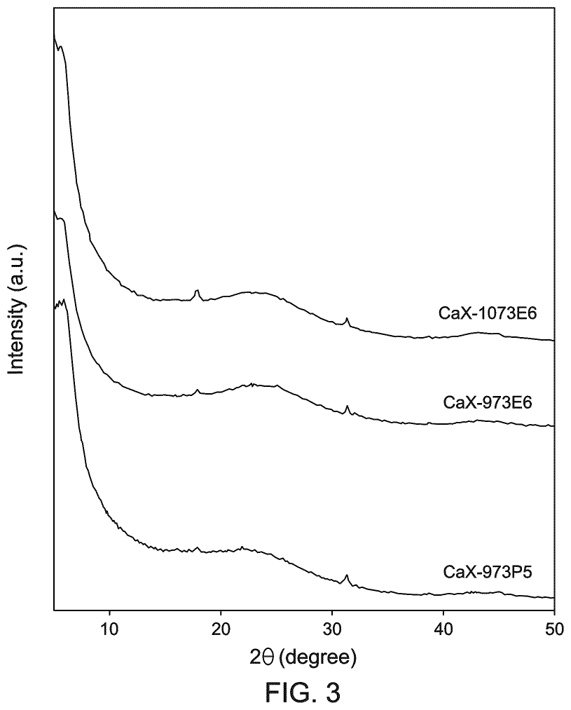

Referring to FIG. 2, NH₃ temperature programmed desorption profiles of CaX and commercial NaX are shown. CaX shows two desorption peaks at 473 K and 653 K. These two desorption peaks indicate the presence of two different types of acid sites. NaX shows no desorption profiles and thus no acidity sites.

Additionally, as shown in Table 1, below, the acid sites generate thermal stability in the template during the carbon vapor deposition.

TABLE 1
Thermal Stability of NaX and CaX Zeolites

| Zeolite | A_{z} | Tᵢₙᵢₜ (K) | T_{0.5} (K) |
|---|---|---|---|
| NaX | 1 | 933 | 1043 |
| CaX | 0.93 | 983 | 1153 |

In Table 1, A_{z} is the equivalent fraction of exchange cation in zeolite; Tᵢₙᵢₜ is the temperature in K at which structural degradation is first observed from the X-ray diffraction pattern; and T_{0.5} is the temperature in K at which the structure is 50% decomposed. Advantageously, the increased stability of CaX at temperatures such as 973 K allows for the CaX zeolite to be utilized in higher temperature carbon vapor deposition processes.

In some embodiments, CaX can be prepared according to the procedure described herein and can be utilized as the zeolite in the generation of multiple ZTCs. Propylene and ethanol can be utilized as organic precursors. In some embodiments, the organic precursor stream is 2 vol % propylene in an inert gas stream saturated with ethanol using a bubbler at 6 kPa. In some embodiments, the organic precursor stream is 2 vol % acetylene in an inert gas stream. In other embodiments, pure propylene or ethanol streams are utilized as the organic precursor. In some embodiments, the organic precursor can be either propylene or ethanol and can have a concentration of 3 to 5 vol % in an inert gas stream. In some embodiments, the organic precursor stream is 2 vol % propylene in a He stream saturated with ethanol using a bubbler at 6 kPa. In some embodiments, the organic precursor stream is 2 vol % acetylene in a He stream. In other embodiments, pure propylene or ethanol streams are utilized as the organic precursor. In some embodiments, the organic precursor can be either propylene or ethanol and can have a concentration of 3 to 5 vol % in a helium stream. In some embodiments, the organic precursor stream is 10 vol % propylene in a N₂ stream. The flow rate for the organic precursor can be 200 mL/min-g_{(zeolite)}.

The organic precursor is utilized in carbon vapor deposition for a specified period of time and at a specified temperature, which can vary. In some preferred embodiments, the specified temperature is in a range from 823 K to 1073 K; alternately, a range from 823 K to 873 K; and alternately, a range from 1023 K to 1073 K. The specified temperature can be in the range of 800 K to 1080 K; alternately, 820 K to 1180 K; alternately, 823 K to 873 K; alternately, 823 K to 973 K; alternately, 823 K to 1073 K; alternately, 870 K to 1023 K; alternately, 873 K to 973 K; and alternately, 873 K to 1023 K. In some embodiments, the specified temperature is in the range of 970 K to 1000 K. In some embodiments, the specified temperature is 823 K, alternately 873 K, alternately 973 K, alternately 1023 K, and alternately 1073 K. In some embodiments, the carbon vapor deposition time is in the range of 2 to 9 hours, alternately 4 to 9 hours, and alternately 4 to 5 hours. In some embodiments, the carbon vapor deposition time is 2 hours, alternately 4 hours, alternately 5 hours, alternately 6 hours, and alternately 9 hours. The ZTC-zeolite composition can be rinsed with a HCl, HF, and water solution of 3.4 wt % HCl and 3.3 wt % HF twice at room temperature for 1 hour. The material is filtered, washed, and dried at a drying temperature. In some embodiments, the drying temperature is 373 K. Embodiments of ZTCs generated using the methods disclosed herein are listed in Table 2, below.

TABLE 2
CaX Generated ZTCs

| | | Temperature of | Carbon Vapor |
|---|---|---|---|
| | Organic | Carbon Vapor | Deposition |
| ZTC Type | Precursor | Deposition (K) | Time (Hr) |
| CaX-973P5 | Propylene | 973 | 5 |
| CaX-973E6 | Ethanol | 973 | 6 |
| CaX-1073E6 | Ethanol | 1073 | 6 |
| CaX-1023A2 | Acetylene | 1023 | 2 |

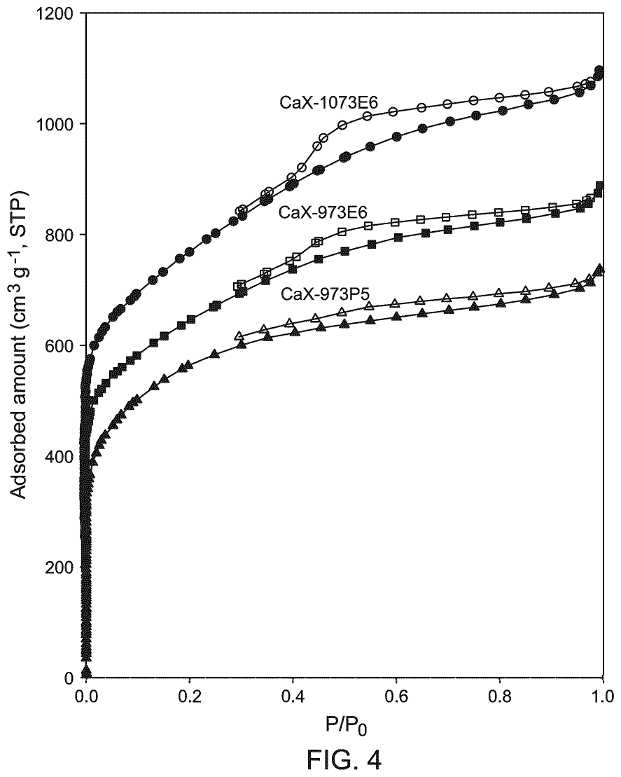

Referring to FIG. 3, X-ray diffraction pattern results for selected ZTCs of Table 2 show a broad peak at 2θ=5-6° indicates the presence of structural order in the micropore arrangement. The CaX-973P5 shows the highest resolution peak, which would indicate the most faithful replication of the CaX template.

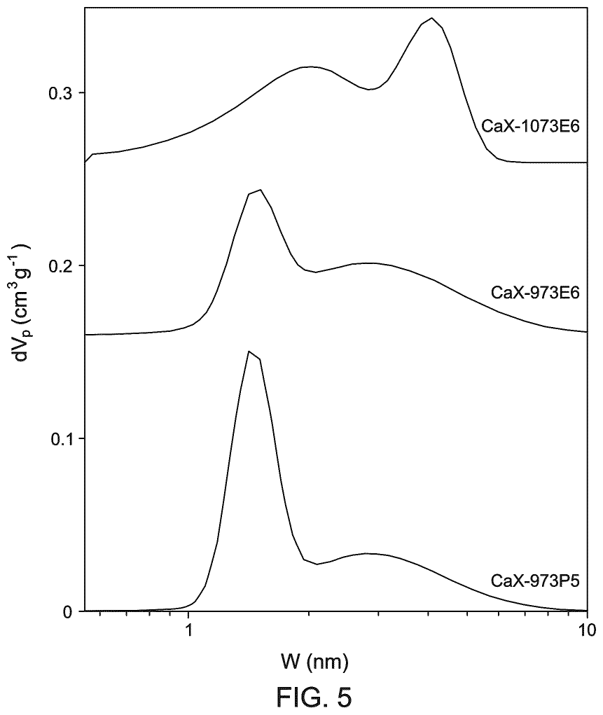

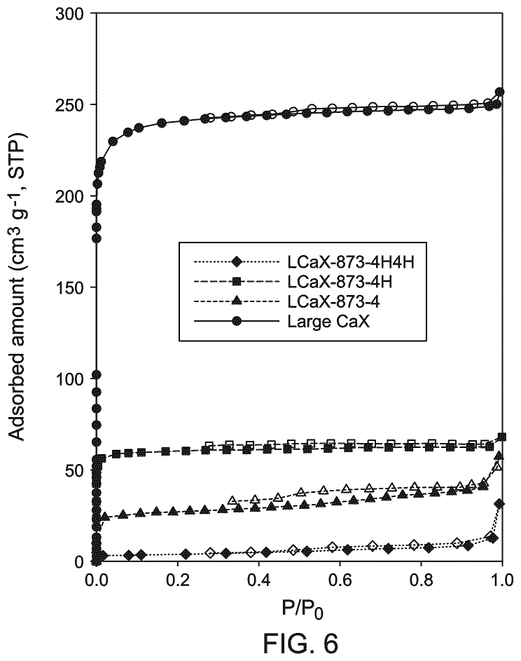

Referring to FIG. 4, N₂ adsorption and desorption isotherms for selected ZTCs of Table 2 are depicted. Referring to FIG. 5, the pore size distribution for selected ZTCs of Table 2 are shown. FIGS. 4 and 5 indicate that the ZTCs show a dual porosity of both micropores in the 1.5 to 2 nm diameter range and mesopores in the 2 to 5 nm diameter range. The distributions were calculated using the non-local density functional theory algorithms. The Brunauer-Emmett-Teller (BET) surface area and pore volumes (micropore, mesopore, and total) for selected ZTCs are shown in Table 3, below:

TABLE 3
BET Surface Area and Pore Volumes of ZTCs

| | S_{BET} | V_{micro} | Vₘₑₛₒ | Vₜₒₜₐₗ |
|---|---|---|---|---|
| ZTC Type | (m²/g) | (cm³/g) | (cm³/g) | (cm³/g) |
| CaX-973P5 | 1915 | 0.75 | 0.34 | 1.09 |
| CaX-973E6 | 1596 | 0.58 | 0.48 | 1.06 |
| CaX-1073E6 | 1826 | 0.65 | 0.66 | 1.31 |
| CaX-1023A2 | 2567 | 0.95 | 0.42 | 1.37 |

In Table 3, V_{micro} (cm³/g) is calculated using the DR equation. The presence of mesopores >0.40 cm³/g as shown in Table 3 and FIGS. 4 and 5 indicated that the microporous structure of the CaX is unfaithfully replicated in some areas since CaX only features micropores. This is likely due to the incomplete filling of the zeolite structure micropores with carbon. CaX-1023A2 in Table 3 uses an acetylene carbon precursor and features a higher surface area and the highest micropore volume in comparison with the other ZTCs generated. Not to be bound by theory, but it is believed that the small kinetic diameter of acetylene results in the most faithful replication of the zeolite of the three organic precursors disclosed herein.

In some embodiments, the ZTC is generated using acetylene as the carbon precursor for carbon vapor deposition utilizing a large crystal CaX (LCaX). LCaX can have a large crystallite size in the range of 10 to 20 μm. Advantageously, the use of LCaX results in improved reproducibility, the ability to scale production and still have positive and consistent characteristics when greater than 1 g of zeolite is utilized, and better commercial application.

During carbon vapor deposition of the LCaX, the elevated temperature can be in the range of 800 K to 1080 K; alternately, 820 K to 1180 K; alternately, 823 K to 873 K; alternately, 823 K to 973 K; alternately, 823 K to 1073 K; alternately, 870 K to 1023 K; alternately, 873 K to 973 K; and alternately, 873 K to 1023 K. In some embodiments, the elevated temperature in is the range of 970 K to 1000 K. In some embodiments, the elevated temperature is 823 K, alternately 873 K, alternately 973K, and alternately 1023 K. In some embodiments, the zeolite-ZTC composite is heat treated after carbon vapor deposition for the purposes of graphitization. The graphitization can be performed utilizing a noble gas. The graphitization can be performed utilizing an inert gas. The noble gas can include helium. The inert gas can include nitrogen. The graphitization temperature can be less than or equal to 1123 K. In some embodiments, the graphitization temperature is in the range of 1100 K to 1180 K. In some embodiments, the graphitization temperature is in the range of 820 K to 1180 K. In some embodiments, the graphitization temperature is in the range of 1123 K to 1173 K. In some embodiments, the graphitization temperature is 1123. In some embodiments, the graphitization temperature is 1173 K. In further embodiments, a second carbon vapor deposition can be performed, followed optionally by a second graphitization. The temperatures of the second carbon vapor deposition and graphitization can be different from, or the same as, those of the first carbon vapor deposition and graphitization.

In some embodiments, two or more rounds of carbon vapor deposition occurs. In these embodiments, the ZTC-zeolite composition is cooled after the first carbon vapor deposition. The ZTC-zeolite composition is reheated, and carbon vapor deposition occurs a second time. Additional cycles can be performed. After the carbon vapor deposition cycles are completed, the ZTC-zeolite composition is cooled and undergoes acid washing to produce the ZTC.

Embodiments of LCaX-generated ZTCs are disclosed below in Table 4. These embodiments utilized acetylene as the organic precursor.

TABLE 4
LCaX-Generated ZTCs

| | Carbon | First | Second | | |
|---|---|---|---|---|---|
| | Vapor | Carbon | Carbon | | |
| | Deposition | Vapor | Vapor | Zeolite | Heat |
| | Temperature | Deposition | Deposition | Amount | Treatment |
| ZTC Type | (K) | Time (hr) | Time (hr) | (g) | Performed |
| LCaX-1023- | 1023 | 2 | — | 1 | No |
| 2a | | | | | |
| LCaX-1023- | 1023 | 2 | — | 5 | No |
| 2b | | | | | |
| LCaX-973-3 | 973 | 3 | — | 1 | No |
| LCaX-873-4 | 873 | 4 | — | 1 | No |
| LCaX-873- | 873 | 4 | — | 1 | Yes |
| 4H | | | | | |
| LCaX-873- | 873 | 4 | 4 | 1 | Yes |
| 4H4Ha | | | | | |
| LCaX-873- | 873 | 4 | 4 | 5 | Yes |
| 4H4Hb | | | | | |
| LCaX-823- | 823 | 9 | 4 | 5 | Yes |
| 9H4H | | | | | |

The Brunaucr-Emmett-Teller (BET) surface area and pore volumes (micropore, mesopore, and total) for selected LCaX-generated ZTCs are shown in Table 5, below:

TABLE 5
BET Surface Area and Pore Volumes of LCaX-Generated ZTCs

| | S_{BET} | V_{micro} | Vₘₑₛₒ | Vₜₒₜₐₗ |
|---|---|---|---|---|
| ZTC Type | (m²/g) | (cm³/g) | (cm³/g) | (cm³/g) |
| LCaX-1023-2a | 2567 | 0.95 | 0.42 | 1.37 |
| LCaX-1023-2b | 2156 | 0.83 | 0.43 | 1.26 |
| LCaX-973-3 | 2381 | 0.93 | 0.31 | 1.24 |
| LCaX-873-4 | 841 | 0.33 | 0.12 | 0.45 |
| LCaX-873-4H | 3049 | 1.12 | 0.45 | 1.57 |
| LCaX-873- | 2830 | 1.10 | 0.23 | 1.33 |
| 4H4Ha | | | | |
| LCaX-873- | 2840 | 1.12 | 0.21 | 1.33 |
| 4H4Hb | | | | |
| LCaX-823-9H4H | 2950 | 1.17 | 0.18 | 1.35 |

In Table 5, V_{micro} (cm³/g) is calculated using the DR equation. Table 5 shows that higher carbon vapor deposition temperature results in higher surface area and higher micropore volume. Lower temperatures, such as the 873 K temperature used in LCaX-873-4, result in lower surface area. However, heat treatment results in a higher surface area and a higher micropore volume. Not to be bound by theory, but it is believed that graphitizing the samples through heat treatment results in maintaining the highly microporous structure such that the structure does not collapse after the zeolite is removed. Data in Table 5 also indicates that carbon vapor deposition using acetylene is sensitive to increases in the starting quantity of the zeolite template due to increases in bed thickness. Thus, LCaX-1023-2b shows a decrease in surface area and pore volume compared to LCaX-1023-2a, even though the only difference is the starting quantity of zeolite template utilized.

In some embodiments, sequential carbon synthesis is utilized to generate the ZTCs. Advantageously, the sequential carbon synthesis overcomes some of the barriers in scalability of acetylene carbon vapor deposition disclosed above. In some embodiments, a first carbon vapor deposition of acetylene is performed at a first temperature, followed by a graphitization at a graphitization temperature. The first temperature can be less than or equal to 873 K. In some embodiments, the first temperature is in the range of 800 K to 873 K. In preferred embodiments, the first temperature is in the range of 823 K to 873 K. The range of 823 K to 873 K can be considered an optimum temperature for initial acetylene carbon vapor deposition due to enhanced surface area and higher micropore volume synthesis. In other embodiments, the temperature can be in the range of 800 K to 1080 K; alternately, 820 K to 1180 K; alternately, 823 K to 873 K; alternately, 823 K to 973 K; alternately, 823 K to 1073 K; alternately, 870 K to 1023 K; alternately, 873 K to 973 K; and alternately, 873 K to 1023 K.

The graphitization can be performed utilizing a noble gas. The graphitization can be performed utilizing an inert gas. The noble gas can include helium. The inert gas can include nitrogen. The graphitization temperature can be less than or equal to 1123 K. In some embodiments, the graphitization temperature is in the range of 1100 K to 1180 K. In some embodiments, the graphitization temperature is in the range of 820 K to 1180 K. In some embodiments, the graphitization temperature is in the range of 1123 K to 1173 K. In some embodiments, the graphitization temperature is 1123. In some embodiments, the graphitization temperature is 1173 K. In further embodiments, a second carbon vapor deposition can be performed, followed optionally by a second graphitization. The temperatures of the second carbon vapor deposition and graphitization can be different from, or the same as, those of the first carbon vapor deposition and graphitization.

Not to be bound by theory, but it is believed that acetylene deposition at lower temperatures such as 873 K results in uniform carbon deposition across the entirety of the zeolite bed, while the heating of the composition at 1123 K under an inert gas like helium results in the densification and graphitization of the carbon structure. The combination results in a uniform and selective desorption of highly graphitized carbons within the zeolite micropores, leading to a high surface area and high micropore volume. Not to be bound by theory, but it is believed the incomplete filling of the zeolite template micropores leads to the formation of mesopores in the ZTC.

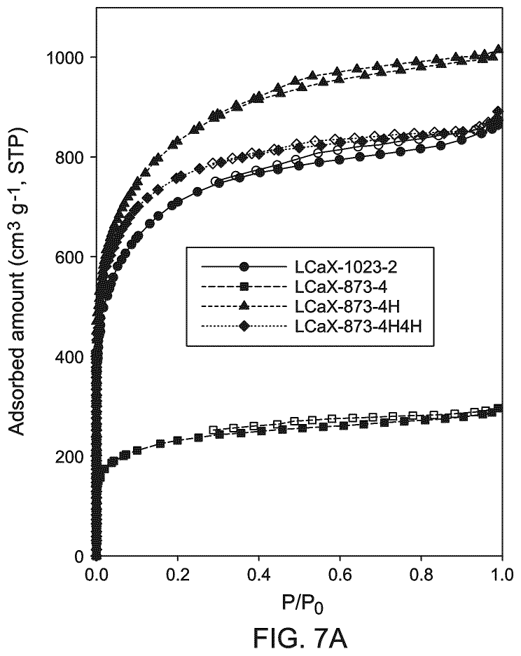

Referring to FIG. 6, the N₂ adsorption and desorption isotherms of the ZTC-zeolite composition (prior to zeolite template removal with acid washing) for the LCaX-generated ZTCs are shown. The ZTC-zeolite composition of LCaX-873-4 showed negligible microporosity remaining inside the zeolite template, indicating in theory that the zeolite micropore is fully filled with the ZTC carbon framework. The results of the ZTC-zeolite composition of LCaX-873-4H indicate that after heat treatment at 1123 K for 4 hours to graphitize the carbon structure, about 25% of the zeolite micropore volume is regenerated, further indicating that heat treatment leads to densification and volume shrinkage of the ZTC carbon framework within the zeolite template micropores. Due to the regeneration of the zeolite micropore volume, a second carbon vapor deposition can be beneficial, followed optionally by a second graphitization. FIG. 6 indicates that the micropore of the zeolite template in the LCaX-873-4H4H ZTC-zeolite composite is fully filled with the graphitized ZTC carbon framework. After acid washing, the LCaX-873-4H4H ZTC retains surface area while showing a reduction in mesopore volumes. As shown in Table 5 and FIG. 6, comparisons of the characteristics of LCaX-873-4H4Ha and LCaX-873-4H4Hb indicated that the sequential carbon synthesis allows for consistent reproduction of the carbon structure in the ZTC regardless of the quantity of zeolite utilized or the bed thickness of the zeolite in the reactor.

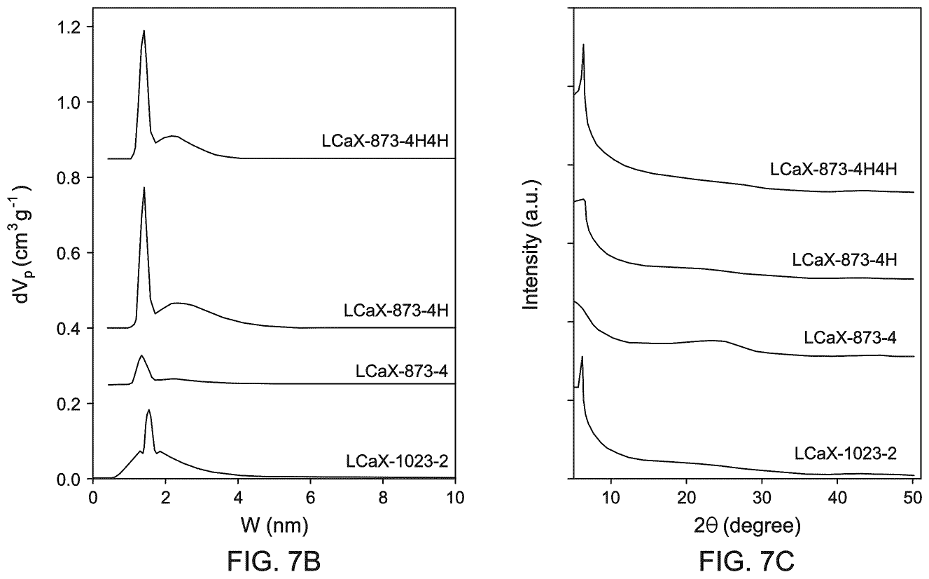

Referring to FIGS. 7A, 7B, and 7C, N₂ adsorption isotherms and X-ray diffraction patterns for the LCaX-generated ZTCs are shown. LCaX-873-4H4H appears to be the most faithfully replicated carbon structure, and show Type I isotherm with a small amount of N₂ adsorption at high pressure regime (P/Po>0.1). LCaX-873-4H shows a higher total pore volume than LCaX-873-4H4H due to the presence of secondary mesoporosity as indicated by the more pronounced adsorption at P/Po>0.1. LCaX-873-4H and LCaX-873-4H4H show narrower and more intense pore size distribution in the micropore regime (2 nm). LCaX-873-4H4H showed very sharp peak at 2θ=6.3° in the X-ray diffraction, indicating that the replicated carbon has an ordered microporous structure like the zeolite template. Therefore, the presence of sharp X-ray diffraction peak at 2θ=6.3° can be used as an indicator for judging the faithful replication of zeolite structure and the efficiency of carbon deposition. Ultimately, the results of the isotherms and X-ray diffraction patterns for the LCaX-generated ZTCs show the pores are concentrated in the micropore region with sharp peaks at less than about 2 nanometers.

Supercapacitors featuring electrodes containing ZTCs generated from the methods disclosed herein can show substantial performance improvement over conventional supercapacitors utilizing activated carbon as electrode active material. ZTCs generated from the carbon vapor deposition of propylene organic vapor precursor can be utilized as the electrode active material. In some embodiments, the propylene organic vapor precursor is a 10% propylene in N₂ gas stream. In some embodiments, after carbon vapor deposition, the ZTC-zeolite composition is graphitized through heat treatment as described herein.

Example ZTCs were synthesized from CaX utilizing a 10 vol % propylene in N₂ gas stream as an organic precursor and was used as an electrode material. A bubbling fluidized bed reactor was utilized to continuously agitate the zeolites and allowed for rapid heat transfer during the carbon vapor deposition process. A bead-type NaX zeolite obtained from Shanghai Jiuzhou Chemicals with 400 to 800 μm particle size distribution. For the examples, 250 g of NaX zeolite was placed inside a quartz tube with an inner diameter of 70 mm and a tube height of 1 m. The temperature was increased to 973 K under a nitrogen flow of 3 L/min. The nitrogen flow was then changed to a flow of 2 to 30 L/min, and the temperature was maintained for 15 minutes. Propylene was co-injected with the nitrogen at a rate of 3.2 vol % propylene/N₂. Some examples utilized a 10 vol % propylene in nitrogen stream. After carbon vapor deposition with the propylene, the ZTC-zeolite compositions were graphitized through heat treatment at 1173 K. The reactor was heated at a temperature climb of 2 K/min with nitrogen at a rate of 2 L/min. The temperature was held for a period of 3 hours, allowing for the densification of the deposited carbon framework. After cooling to room temperature, the ZTC-zeolite compositions then underwent acid washing with 0.2 M HCl and 0.48 M HF composition twice and dried at 373 K overnight.

The characteristics of the ZTC generated and utilized for the supercapacitor electrode generated from the processes outlined above has a surface area of approximately 3056 m²/g, a micropore volume of 1.12 cm³/g, and a total pore volume of 1.72 cm³/g.

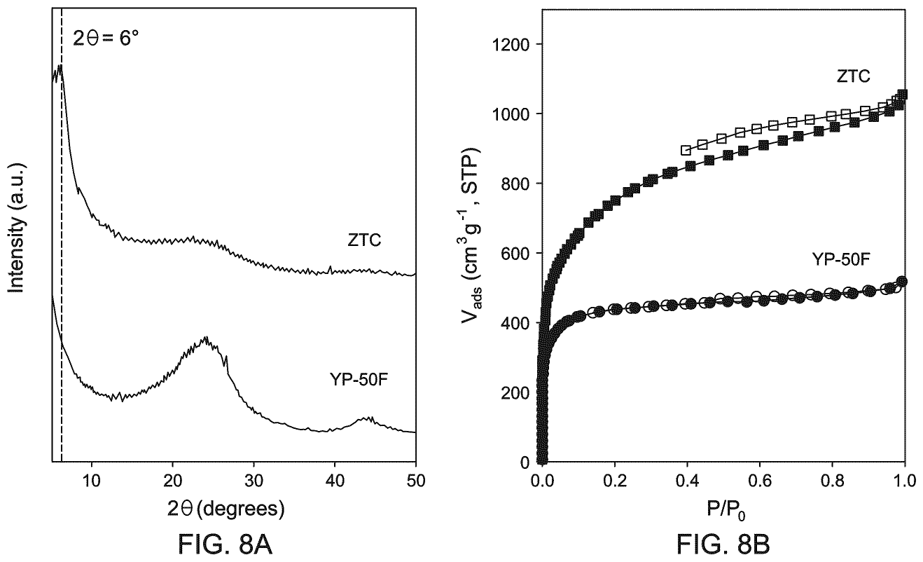

The propylene-based ZTC was compared against a commercially available activated carbon from Kuraray Chemical Co. designated YP-50F. Referring to FIGS. 8A and 8B, X-ray diffraction and N₂ adsorption and desorption isotherms of the propylene-based ZTC and YP-50F are shown. The propylene-based ZTC showed a much large surface area of 2700 m²/g and micropore volume of 0.99 cm³/g in comparison to the YP-50F, which showed a surface area of 1665 m²/g and a micropore volume of 0.66 cm³/g.

The capacitive performance of the propylene-based ZTC was examined against that of YP-50F in capacitor applications. The ZTC was synthesized at a large scale using a bubbling fluidized bed reactor and the procedures outlined above using a 10 vol % propylene/nitrogen mixture. Heat treatment was performed at 1173 K for 3 h to more graphitize the deposited carbon framework. The generated ZTC was labeled as ‘ZTC-15 L min⁻¹-1173 K.’ The generated ZTC was utilized as an electrode and tested. These results were compared to an electrode generated with a commercial activated carbon, YP-50F (from Kuraray Chemical Co.), as a reference material. The propylene-based ZTC and the YP-50F were examined using a 1 M H₂SO₄ electrolyte in a 2032 type two-electrode coin cell (sourced from MTI Co.), with a 20 mm diameter and a 3.2 mm height. The working electrodes were prepared by mixing the ZTC or YP-50F with polyvinylidine fluoride (PVDF) binder and commercial carbon black (Super PR sourced from TIMCAL Graphite & Carbon) in N-methyl 2-pyrrolidone (NMP). The weight ratio of active material:PVDF:carbon black was set to 7:1:2. The slurry was coated on stainless steel foil (current collector) using a doctor blade, and the thickness of the coated layer was adjusted to 100 μm. The electrodes were dried at 80° C. for 1 day and punched into a circular electrode 14 mm diameter. The symmetrical coin cell was constructed using a pair of circular electrodes (ca. 1.4 mg) and glass microfiber paper (18 mm diameter, grade GF/F) as a separator. The prepared coin cell was fixed on the coin cell holder to evaluate electrochemical properties.

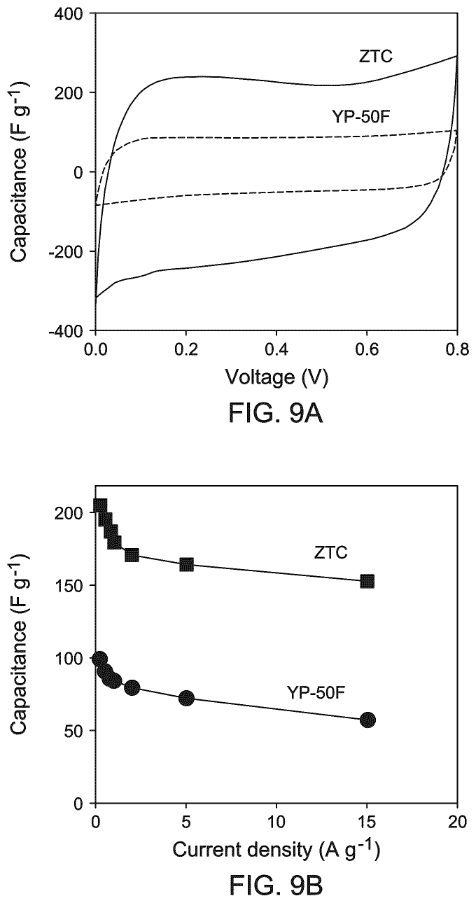

Referring to FIG. 9A, the cyclic voltammetry responses of the electrodes are shown. YP-50F displayed a conventional rectangular shape, which indicates a pure capacitive behavior in the voltage window. However, the propylene-based ZTC displayed a non-rectangular pattern and broad reversible peak at 0.2 V which can be attributed to the quinone-hydroquinone redox reaction. The hydroquinone is added to the IM H₂SO₄ as a redox additive or mediated electrolyte. The hydroquinone is directly involved in the electron transfer redox reaction. The performance of the supercapacitor is improved by their surface pseudocapacitive contribution at the electrode-electrolyte interface. During charging, the hydroquinone is oxidized into quinone with 2H⁺ and 2e⁻ and during discharge, the quinone is reduced into hydroquinone via gain of 2e⁻ with 2H⁺ at its corresponding oxidation and reduction potentials, respectively. This redox property of hydroquinone predominantly exhibits pseudo-capacitance at the electrolyte-electrode interface and contributed to increasing the total capacitance of the supercapacitor. A ZTC with larger total pore volume in comparison with YP-50F (having a surface area of 1665 m²/g and a total pore volume of 0.66 cm³/g) can store more hydroquinone at the interface of the electrode-electrolyte and thus has a higher capacitance. The propylene-based ZTC also displayed a significantly higher capacitance of 209 F/g compared to the YP-50F capacitance of 103 F/g.

Referring to FIG. 9B, the specific discharge capacitance as a function of current density of the electrodes are shown. At high current density resulting in a fast discharge rate, the ion transfer between the bulk electrolyte and the surface of the electrode needs to be extremely fast. YP-50F retained only 58% of the initial capacitance at 15 A/g, while the propylene-based ZTC maintained 75% of its capacitance at the same rate. Not to be bound by theory, but it is believed that the enhanced performance can be attributed to the uniform, three-dimensionally connected micropore channels allowing for fast ion diffusion of the electrolytes.

1. A method for generating a zeolite-templated carbon (ZTC) for use as an active material in an electrode in a supercapacitor, the method comprising the steps of:
providing a CaX zeolite at a select size;
performing carbon vapor deposition on the CaX zeolite in a plug-flow reactor using an organic precursor to generate a ZTC-zeolite composition, wherein the carbon vapor deposition occurs at an elevated temperature;
cooling the ZTC-zeolite composition; then
heating the ZTC-zeolite composition by introducing an inert gas stream for a defined period of time, wherein the ZTC is heated to a graphitizing temperature in the range of 820 K to 1180 K, to generate a graphitized ZTC-zeolite composition;
cooling the graphitized ZTC-zeolite composition; and
washing the graphitized ZTC-zeolite composition with acid to generate a prepared ZTC, the prepared ZTC having a select surface area and operable for use as an active material in an electrode in a supercapacitor.

2. The method of claim 1, wherein the inert gas stream comprises helium.

3. The method of claim 1, wherein the inert gas stream comprises nitrogen.

4. The method of claim 1, wherein the organic precursor is selected from the group consisting of: propylene, ethanol, acetylene, and combinations of the same.

5. The method of claim 1, wherein the organic precursor comprises propylene.

6. The method of claim 1, wherein the acid is selected from the group consisting of: HCl, HF, and combinations of the same.

7. The method of claim 1, further comprising the step of drying the prepared ZTC.

8. The method of claim 1, wherein the prepared ZTC defines micropores in the range of 1.5 to 2 nm and mesopores in the range of 2 to 5 nm.

9. The method of claim 1, wherein the elevated temperature is in the range of 800 K to 1080 K.

10. A supercapacitor comprising:
an electrode, the electrode comprising an active material and a metallic component, wherein the active material comprises a zeolite-templated (ZTC) generated by the method of claim 1;
an electrolyte comprising H₂SO₄; and
g membrane separator.

11. The supercapacitor of claim 10, wherein the supercapacitor retains a maximum of 75% of capacitance at high current densities of 15 A/g.

12. The supercapacitor of claim 10, wherein the ZTC has a surface area in the range of 2500 m²/g to 3000 m²/g.

13. The supercapacitor of claim 10, wherein the ZTC has a micropore density of greater than 1.0 cm³/g.

14. The supercapacitor of claim 10, wherein the supercapacitor has a capacitance is in the range of 100 to 250 F/g.

15. A method for generating a zeolite-templated carbon (ZTC) for use as an active material in an electrode in a supercapacitor, the method comprising the steps of:
providing a NaX zeolite;
initiating ion exchange with the NaX zeolite and Ca⁺² ions to generate a large crystalline calcium (LCaX) zeolite;
performing carbon vapor deposition on the LCaX zeolite in a plug-flow reactor using acetylene to generate a ZTC-zeolite composition, wherein the carbon vapor deposition occurs at an elevated temperature;
heating the ZTC by introducing an inert gas stream for a defined period of time, wherein the ZTC is heated to a graphitizing temperature in the range of 820 K to 1180 K, generating a graphitized ZTC-zeolite composition;
cooling the graphitized ZTC-zeolite composition; and
washing the graphitized ZTC-zeolite composition with acid, generating a prepared ZTC, the prepared ZTC having a select surface area and operable for use as an active material in an electrode in a supercapacitor.

16. The method of claim 15, wherein the inert gas stream comprises helium.

17. The method of claim 15, wherein the elevated temperature is in the range of 820 K to 873 K.

18. The method of claim 15, further comprising the steps of:
Performing a second carbon vapor deposition on the graphitized ZTC-zeolite composition using acetylene, wherein the second carbon vapor deposition is performed at the elevated temperature.

19. The method of claim 15, wherein the elevated temperature is in the range of 800 K to 873 K.

20. The method of claim 15, wherein the acid is selected from the group consisting of: HCl, HF, and combinations of the same.
